(19) United States
(12) Patent Application Publication
(10) Pub. No.: US 2010/0075648 A1
(43) Pub. Date: Mar. 25, 2010

(54) SYSTEM AND METHOD TO LOCALIZE APPLICATIONS ON A MOBILE COMPUTING DEVICE

(75) Inventors: Yoshimichi Matsuoka, Cupertino, CA (US); Douglas B. Luftman, Cupertino, CA (US)

Correspondence Address: FENWICK & WEST LLP, SILICON VALLEY CENTER, 801 CALIFORNIA STREET, MOUNTAIN VIEW, CA, 94041, US

(73) Assignee: Palm, Inc., Sunnyvale, CA (US)

(21) Appl. No.: 12/237,237

(22) Filed: Sep. 24, 2008

(51) Int. Cl. H04M 3/00

(52) U.S. Cl. 455/418

(57) ABSTRACT

A method (and corresponding system and computer program product) for localizing applications on a computing device to the current device geographic location is described. In one embodiment, a method detects the location of the computing device, identifies an applicable location profile based on the device location, the applicable location profile containing a rule for localizing an application on the mobile computing device, and localizes the application based on the rule. In another embodiment, a method correlates multiple local times by determining a local time of the device location, adjusting an existing schedule based on the local time and user preference information, and generating a notification based on the adjusted schedule and the user preference information.

### BACKGROUND

1. Field of Disclosure

The disclosure generally relates to the field of application customization, in particular to application localization.

2. Description of the Related Art

As mobile phones become more powerful and reliable, people increasingly depend on their mobile phones for providing important functions (e.g., phone call, email, and appointment schedule). However, when people travel to different geographical locations, particularly in different time zones, their mobile phones do not properly localize without extensive manual user interventions. This causes significant inconvenience to users of such devices.

One conventional approach to localize a mobile phone is to provide users with options to manually adjust the system and applications residing within the device. For example, the user can manually adjust the system time to be in synchronization with the local time. This process is subject to user errors, for example, due to guessing day light saving differences from location to location and/or across the International Date Line.

Another conventional approach to localize a mobile phone involves automatic clock synchronization (e.g., with local mobile towers) and calendar adjustment. However, this approach is problematic. For example, such adjustment does not take into consideration the user's pre-populated calendar preferences such as recurrences on particular days and times. For example, while a user is traveling abroad and in a different time zone, a repeat reminder of a monthly social gathering scheduled regularly at 7 AM back at home may go off after midnight at the new location, causing unnecessary distress to the user.

Thus, the art lacks, inter alia, a system and method for efficiently localizing applications in a mobile computing device.

### SUMMARY

Embodiments of the present disclosure include a method (and corresponding system and computer program product) that localizes a computing device to the current geographic location where the device is physically present.

In one embodiment of the present disclosure, a method detects the location of the computing device, identifies an applicable location profile based on the device location, the applicable location profile containing a rule for localizing an application on the mobile computing device, and localizes the application based on the rule.

In another embodiment of the present disclosure, a method correlates multiple local times by determining a local time of the device location, adjusting an existing schedule based on the local time and user preference information, and generating a notification based on the adjusted schedule and the user preference information.

Advantages of the present disclosure include automated application localization. Moreover, the disclosure beneficially includes a process to automatically adjust calendar entries based on detected information of a device's current physical location. This saves a user of the device time and effort in identifying whether events or other information on the device is local or not.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF DRAWINGS

The disclosed embodiments have other advantages and features which will be more readily apparent from the detailed description, the appended claims, and the accompanying drawings, in which:

FIG. 1 is a diagram illustrating one embodiment of a mobile computing device.

FIG. 2 is a block diagram illustrating one embodiment of an architecture of a mobile computing device.

FIG. 3 is a block diagram illustrating one embodiment of a localization manager shown in FIG. 2.

FIG. 4 is a flowchart illustrating an example of one embodiment for localizing applications in a mobile computing device.

FIGS. 5A-5C are screenshots illustrating one embodiment of example prompting messages.

FIGS. 6A-6C are one embodiment of screenshots of a calendar application.

FIGS. 7-8 are one embodiment of screenshots of two example localized applications.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of the disclosure.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### EXAMPLE MOBILE COMPUTING DEVICE

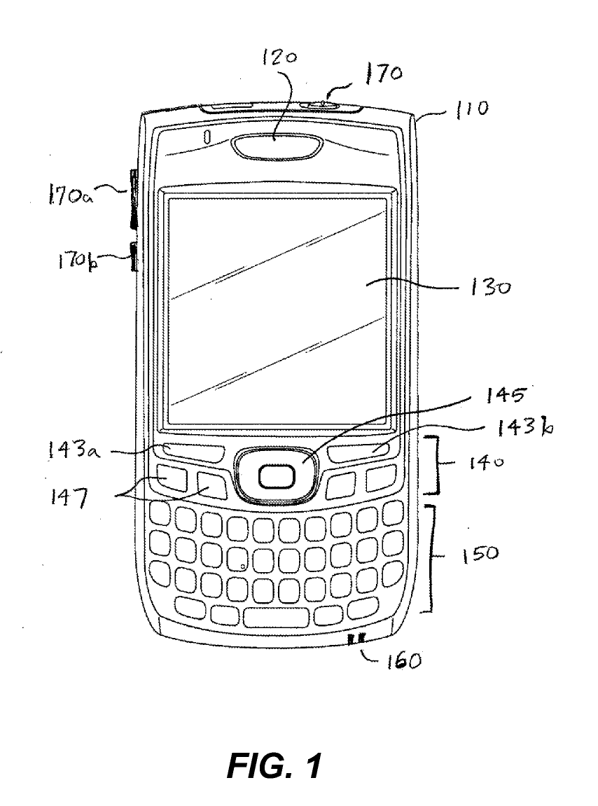

FIG. 1 illustrates one embodiment of a mobile computing device 110 with telephonic functionality, e.g., a mobile phone or a smartphone. The mobile computing device is configured to host and execute a phone application for placing and receiving telephone calls. It is noted that for ease of understanding the principles disclosed herein are in an example context of a mobile computing device 110 with telephonic functionality operating in a mobile telecommunications network. However, the principles disclosed herein may be applied in other duplex (or multiplex) telephonic contexts such as devices with telephonic functionality configured to directly interface with public switched telephone networks (PSTN) or data networks having voice over internet protocol (VoIP) functionality. Moreover, the principles disclosed herein may also be applied to other devices, such as personal digital assistants (PDAs), media players and other similar devices.

The mobile computing device 110 is configured to be of a form factor that is convenient to hold in a user's hand, for example, a personal digital assistant (PDA) or a smart phone form factor. For example, in one embodiment the mobile computing device 110 can have dimensions ranging from 7.5 to 15.5 centimeters in length, 5 to 12.75 centimeters in width, 0.5 to 2.5 centimeters in height and weigh between 50 and 250 grams.

The mobile computing device 110 includes a speaker 120, a screen 130, a navigation area 140, a keypad area 150, and a microphone 160. The mobile computing device 110 also may include one or more switches 170, 170a, 170b (generally 170). The one or more switches 170 may be buttons, sliders, or rocker switches and can be mechanical or solid state (e.g., touch sensitive solid state switch).

The screen 130 of the mobile computing device 110 is, for example, a 240×240, a 32033 320, or a 320×480 transflective display. For example, the screen 130 comprises an active matrix liquid crystal display (AMLCD), a thin-film transistor liquid crystal display (TFT-LCD), an organic light emitting diode (OLED), an interferometric modulator display (IMOD), a liquid crystal display (LCD), or other suitable display device. In an embodiment, the display displays color images. In another embodiment, the screen 130 further comprises a touch-sensitive display (e.g., pressure-sensitive (resistive), electrically sensitive (capacitative), acoustically sensitive (SAW or surface acoustic wave), photo-sensitive (infra-red)) including a digitizer for receiving input data, commands or information from a user. The user may use a stylus, a finger or another suitable input device for data entry, such as selecting from a menu or entering text data.

The navigation area 140 is configured to control functions of an application executing in the mobile computing device 110 and visible through the screen 130. For example, the navigation area includes an x-way (x is e.g., 5) navigation ring (or joystick) 145 that provides cursor control, selection, and similar functionality. In addition, the navigation area 140 may include selection buttons 143a, 143b to select functions viewed just above the buttons on the screen 130. In addition, the navigation area 140 also may include dedicated function buttons 147 for functions such as, for example, a calendar, a web browser, an e-mail client or a home screen. In this example, the navigation ring 145 may be implemented through mechanical, solid state switches, dials, or a combination thereof. The keypad area 150 may be a numeric keypad (e.g., a dial pad) or a numeric keypad integrated with an alpha or alphanumeric keypad (e.g., a keyboard with consecutive keys of QWERTY, AZERTY, or other equivalent set of keys on a keyboard or a Dvorak keyboard).

Although not illustrated, it is noted that the mobile computing device 110 also may include an expansion slot (not shown). The expansion slot is configured to receive and support expansion cards (or media cards), which may include memory cards such as CompactFlash™ cards, SD cards, XD cards, Memory Sticks™, MultiMediaCard™, SDIO, and the like.

The mobile computing device 110 may also include a connector (not shown in FIG. 1) for connections with external computing devices, such as a desktop computer. The connection may be wired (e.g., via a Universal Serial Bus (USB) connection) or wireless (e.g., via a Bluetooth connection). The desktop computer can access and modify data stored in the mobile computing device 110 (e.g. data stored in integrated or embedded storage devices or in expansion cards) through the connection.

### EXAMPLE MOBILE COMPUTING DEVICE ARCHITECTURAL OVERVIEW

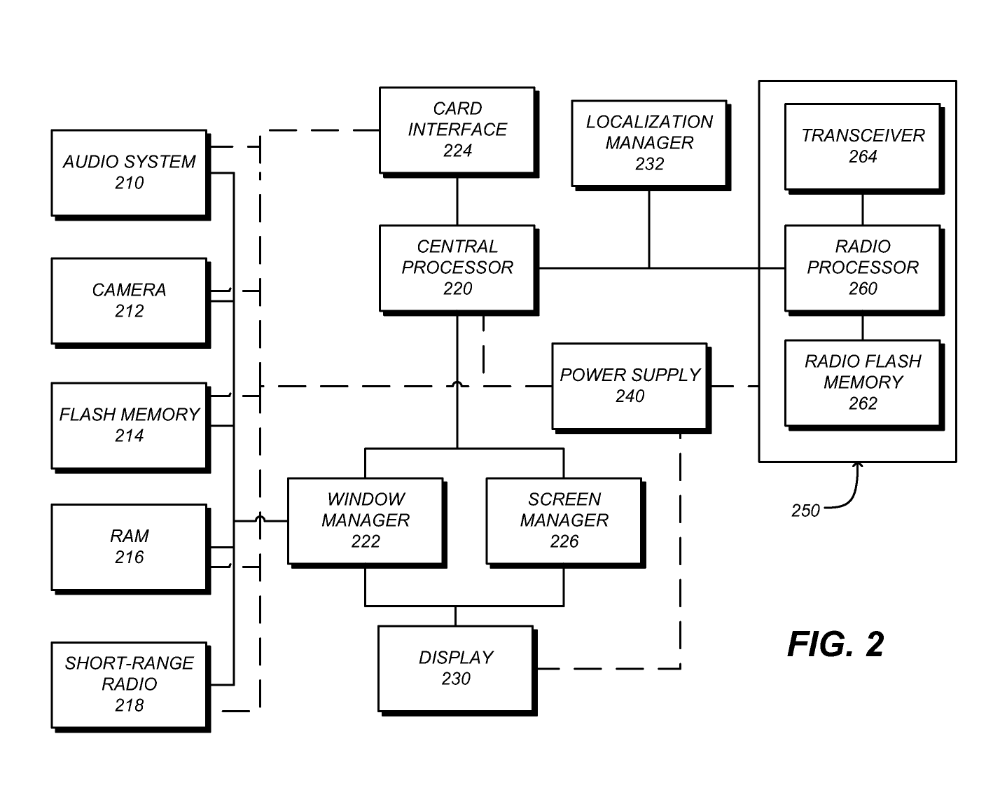

Referring next to FIG. 2, a block diagram illustrates one embodiment of an architecture of a mobile computing device 110 with telephonic functionality. By way of example, the architecture illustrated in FIG. 2 will be described with respect to the mobile computing device of FIG. 1. The mobile computing device 110 includes a central processor 220, a power supply 240, and a radio subsystem 250. The central processor 220 communicates with: audio system 210, camera 212, flash memory 214, random-access memory (RAM) 216, short range radio module 218 (e.g., Bluetooth, Wireless Fidelity (WiFi) component), a window manager 222, a screen manager 226, and a localization manager 232. The power supply 240 powers the central processor 220, the radio subsystem 250 and a display driver 230 (which may be contact- or inductive-sensitive). The power supply 240 may correspond to a battery pack (e.g., rechargeable) or a powerline connection or component.

In one embodiment, the window manager 222 comprises a software or firmware instructions for processes that initialize a virtual display space stored in the RAM 216 and/or the flash memory 214. The virtual display space includes one or more applications currently being executed by a user and the current status of the executed applications. The window manager 222 receives requests, from user input or from software or firmware processes, to show a window and determines the initial position of the requested window. Additionally, the window manager 222 receives commands or instructions to display and modify a window, such as resizing the window along one axis, moving the window along one axis or any other command altering the appearance or position of the window, and modifies the window accordingly.

The screen manager 226 comprises a software or firmware instructions for processes that manage content displayed on the screen 130. In one embodiment, the screen manager 226 monitors and controls the physical location of data displayed on the screen 130 and which data is displayed on the screen 130. The screen manager 226 alters or updates the location of data on the screen 130 responsive to input from the central processor 220, to modify the screen 130 appearance. In one embodiment, the screen manager 226 also monitors and controls screen brightness and transmits control signals to the central processor 220 to modify screen brightness and power usage to the screen 130.

The localization manager 232 comprises a software or firmware instructions for customizing the mobile computing device 110 based on its current geographical location. The localization manager 232 utilizes components such as a GPS receiver to determine the current geographical location of the mobile computing device 110, and localizes systems and/or applications on the mobile computing device 110 based on the device location. In one embodiment, the localization manager 232 determines local time as the mobile computing device 110 travels through different time zones, and adjusts device time and existing schedules (calendar entry, appointment, to do, etc.) accordingly. In one embodiment, the localization manager 232 conducts the localization according to geographical profiles, each of which contains localization rules. In addition, the localization manager 232 tracks user activities and uses the tracked information to adjust future localizations. An example architecture and methodology of the localization manager 232 is further described in detail below.

The radio subsystem 250 includes a radio processor 260, a radio memory 262, and a transceiver 264. The transceiver 264 may be two separate components for transmitting and receiving signals or a single component for both transmitting and receiving signals. In either instance, it is referenced as a transceiver 264. The receiver portion of the transceiver 264 communicatively couples with a radio signal input of the device 110, e.g., an antenna, where communication signals are received from an established call (e.g., a connected or on-going call). The received communication signals include voice (or other sound signals) received from the call and processed by the radio processor 260 for output through the speaker 120. The transmitter portion of the transceiver 264 communicatively couples a radio signal output of the device 110, e.g., the antenna, where communication signals are transmitted to an established (e.g., a connected (or coupled) or active) call. The communication signals for transmission include voice, e.g., received through the microphone 160 of the device 110, (or other sound signals) that is processed by the radio processor 260 for transmission through the transmitter of the transceiver 264 to the established call.

In one embodiment, communications using the described radio communications may be over a voice or data network. Examples of voice networks include Global System of Mobile (GSM) communication system, a Code Division, multiple Access (CDMA system), and a Universal Mobile Telecommunications System (UMTS). Examples of data networks include Voice over IP (VoIP), General Packet Radio Service (GPRS), third-generation (3G) mobile, High Speed Download Packet Access (HSDPA), and Worldwide Interoperability for Microwave Access (WiMAX).

While other components may be provided with the radio subsystem 250, the basic components shown provide the ability for the mobile computing device to perform radio-frequency communications, including telephonic communications. In an embodiment, many, if not all, of the components under the control of the central processor 220 are not required by the radio subsystem 250 when a telephone call is established, e.g., connected or ongoing. The radio processor 260 may communicate with central processor 220 using a bus line (not shown).

The card interface 224 is adapted to communicate with the expansion slot (not shown). The card interface 224 transmits data and/or instructions between the central processor 220 and an expansion card or media card included in the expansion slot. The card interface 224 also transmits control signals from the central processor 220 to the expansion slot to configure an expansion card or media card included in the expansion slot. In one embodiment, the card interface 224 works with a storage driver (not shown) in order to transmit data and/or instructions to and/or from the expansion card or media card included in the expansion slot.

In one embodiment, central processor 220 executes logic (by way of programming, code, instructions) corresponding to executing applications interfaced through, for example, the navigation area 140 or switches 170. It is noted that numerous other components and variations are possible to the hardware architecture of the computing device 110, thus an embodiment such as shown by FIG. 2 is just illustrative of one implementation for an embodiment.

### LOCALIZATION MANAGER ARCHITECTURAL OVERVIEW

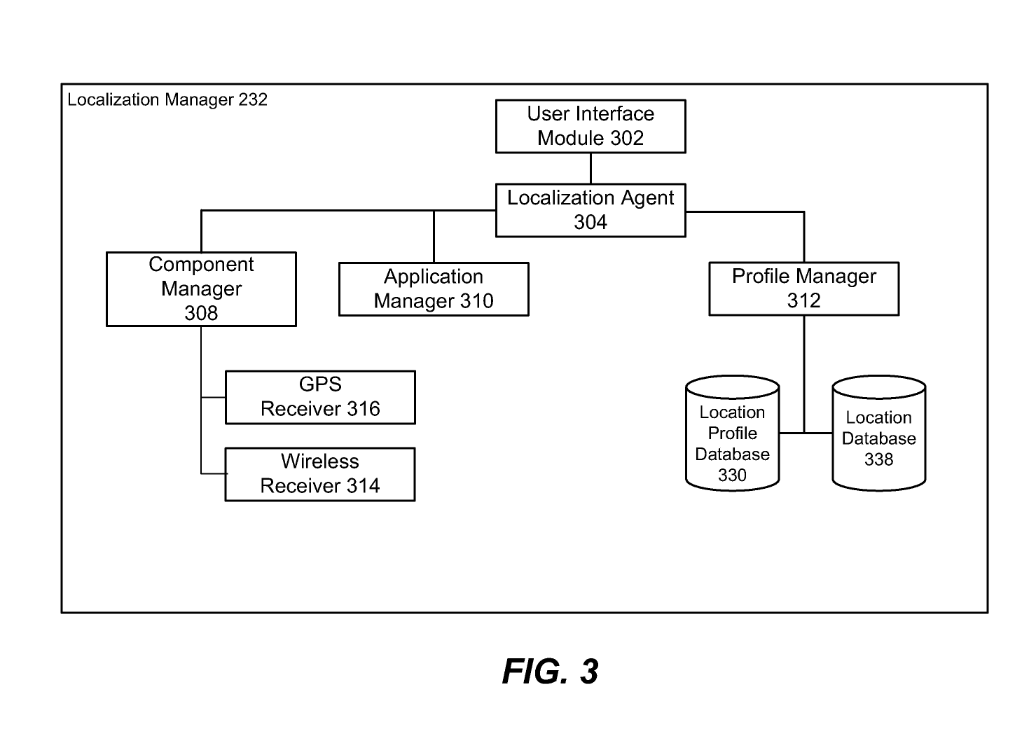

FIG. 3 is a block diagram illustrating one embodiment of the localization manager 232. As illustrated, the localization manager 232 includes a user interface module 302, a component manager 308, an application manager 310, and a profile manager 312, all communicatively connected with a localization agent 304. In one embodiment, each of these components comprises a software or firmware instructions.

The component manager 308 is configured for managing components involved in localizing the mobile computing device 110. There can be multiple components involved in the localization process. Some of the components can be used to determine the device location (e.g., a global positioning system (GPS) receiver 316, a WiFi receiver (not shown), or a wireless receiver 314 such as the transceiver 264). It is noted the component 314, 316 may be integrated into the device 110 architecture, for example, the architecture described above with relate to FIG. 2. Some other components can be used to transmit, retrieve, output, receive, or store localization data (e.g., localization profiles). Examples of these components include the card interface 224 (e.g., when a card containing localized data is inserted into the interface 224) and the short range radio module 218.

The application manager 310 is configured for localizing systems and/or applications on the mobile computing device 110. Examples of such systems include the operating system (e.g., Palm OS, Windows Mobile, Mac OS), and examples of such applications include a calendar application (e.g., Palm Calendar, Microsoft Outlook), a network connection management application, and/or applets such as a clock applet and a currency converter applet. In one embodiment, the application manager 310 customizes a system/application by modifying its configuration data (e.g., registry settings and/or options). For example, for a currency conversion applet, the application manager 310 can specify a default currency in its registry based on the current device location (e.g., Japanese Yen for Tokyo, or British Pound for London).

The profile manager 312 is configured for managing location profiles (also called geographical profiles). Location profiles characterize the device user's preferences in customizing the mobile computing device 110 when he travels to various locations with the device. Location profiles may include a default profile (or home or base profile) for the location where the user is primarily based, and a remote profile (or away profile) for a location where the user frequently travels. It is noted that there may be multiple default profiles and/or remote profiles. There also may be profiles for other locations (hereinafter collectively called dynamic profiles). A location profile is associated with a geographic area (e.g., a city, state/province, country, time zone) and includes localization rules that specify how the mobile computing device 110 should be customized when the device is detected to be present in the associated geographic area. A localization rule describes how one (or multiple) system/application should be modified, how data residing within the mobile computing device 110 should be adjusted, and/or what notification should be triggered. Example localization rules include “No real-time email synchronization outside U.S.” and “Prompt for confirmation before using data connection services inside Japan.”

Consider, for example, for a device user who works in northern California, U.S.A. and frequently travels to Taiwan for vacation. The user's mobile computing device 110 would have two location profiles, a home profile (or default or base profile) and a remote profile. The home profile is the northern California profile and the remote profile is the Taiwan profile. The home profile includes a localization rule specifying that the mobile computing device 110 should trigger a reminder for all business meetings 30 minutes in advance of such scheduled meetings. The remote profile includes a localization rule specifying that unless a meeting is labeled urgent, the mobile computing device 110 should not issue reminders between 8 PM and 8 AM local time (Taiwan time). The user can also set more sophisticated rules, such as if a meeting falls between 8 PM and 8 AM, then an email message will be automatically generated and sent to the meeting organizer notifying that the user will be absent. The remote profile can also include localization rules prompting the user with notifications on screen 130 such as “No non-business reminder between 8 PM and 8 AM in Taiwan.”

The location profiles and the localization rules can be generated and modified by the device user. Alternatively, or in conjunction, the location profiles and the localization rules can be deduced based on past user activities.

The profile manager 312 is configured for providing applicable profile(s) and/or rules for a given device location. For example, if the component manager 308 determines that the device location is in Taiwan, the profile manager 312 can identify the Taiwan profile along with its rules, and other applicable profiles/rules (e.g., rules for locations with wireless services compatible with the third generation of mobile phone standard (3G)). It is noted that more than one location profile may be applicable to a specific location. For example, for San Francisco, the following profiles are all applicable: northern California profile, California profile, U. S. profile, and northern America profile.

The profile manager 312 is also configured to reconcile profile/rule conflicts. Occasionally multiple rules are equally applicable and conflict each other. For example, one applicable rule may mandate vibration reminders for business appointments while another may prohibit all reminders. The profile manager 312 reconciles the confliction by selecting zero (e.g., does not apply any conflicting rules), one, or more rules to execute. The profile manager 312 can either make the selection based on past user behavior (e.g., the user's prior selection in similar situation) or prompt the user for selection. In one embodiment, the profile manager 312 prioritizes rules in location profiles that are most pertinent to the device location. For example, assume the device is located in San Francisco, and a localization rule in the northern California profile conflicts a rule in the northern America profile. The profile manager 312 would prioritize the rule in the northern California profile and not apply the other rule.

As shown in FIG. 3, the profile manager 312 is connected to a location profile database 330 and a location database 338. It is noted that the databases 330,338 are stored in, for example, the flash memory 214, and are accessible by the central processor 220. The location profile database 330 contains location profiles for locations the user has been, scheduled to visit, and/or is likely to go. The location database 338 contains information related to the locations, such as past user activities while the mobile computing device 110 is in the various locations, wireless service providers available in the locations and their price schedules, and information (e.g., layout maps) of major airports/seaports/train stations.

The user interface module 302 is configured for generating a user interface for a user and receiving user interactions through the user interface. The user can setup and edit profile rules and otherwise configure the localization manager 232 through the user interface.

The localization agent 304 is configured for localizing the mobile computing device 110 by coordinating with the user interface module 302, the component manager 308, the application manager 310, and the profile manager 312. In one embodiment, the localization agent 304 detects a device location change though the component manager 308, identifies applicable location profiles/rules through the profile manager 312, and localizes systems/applications through the application manager 310.

### OVERVIEW OF METHODOLOGY

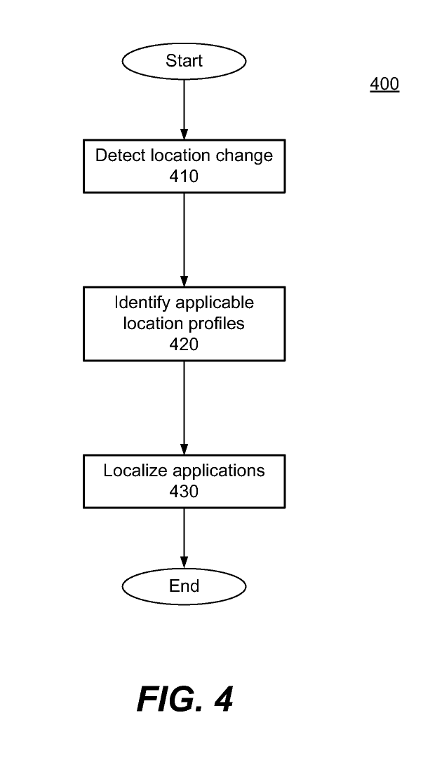

FIG. 4 is a flowchart illustrating an example method (or process) 400 for localizing applications in a mobile computing device. In one embodiment, the method 400 is implemented in a mobile device such as the mobile computing device 110. One or more portions of the method 400 may be implemented in embodiments of hardware and/or software or combinations thereof.

By way of example, the method 400 may be embodied through instructions for performing the actions described herein and such instrumentations can be stored within a tangible computer readable medium, e.g., the flash memory 214 or the RAM 216, and are executable by a processor, e.g., the central processor 220. Alternatively, or in conjunction, the method 400 may be implemented in modules like the localization manager 232. Furthermore, those of skill in the art will recognize that other embodiments can perform the steps of the method 400 in different order. Moreover, other embodiments can include different and/or additional steps than the ones described here.

Initially, the localization manager 232 detects 410 a device location change through the component manager 308. For example, the component manager 308 can determine a device location using the GPS receiver 316 and/or the wireless receiver 314 (e.g., using triangulation), and compare to a previously determined device location to detect 410 location changes. The component manager 308 can be scheduled to make the determination periodically or responsive to predetermined events (e.g., whenever the mobile computing device 110 is turned on).

In one embodiment, the component manager 308 can determine location-dependent information other than the device location. For example, the component manager 308 can receive information about local time and local wireless service providers, for example, through signals received from local mobile towers or wireless network “hotspots”.

The localization manager 232 identifies 420 applicable location profiles for the device location through the profile manager 312. There may be multiple profiles applicable to a single device location. For example, the user can create a location profile for locations outside U.S., and a location profile specifically for Taiwan. Rules in both profiles are applicable when the mobile computing device 110 is found located in Taiwan. If it is determined that several applicable rules are not compatible, the profile manager 312 reconciles the incompatibility by not applying the incompatible rules or by selectively applying one or more compatible rules to execute. The profile manager 312 can either make the selection based on past user behavior (e.g., the user's previous selection in similar situation) or prompt the user for selection.

The localization manager 232 localizes 430 systems and/or applications on the mobile computing device 110 based on the identified location profiles through the application manager 310. As described above with reference to FIG. 3, location profiles contain localization rules about how to customize (or configure) systems and/or applications. The application manager 310 localizes 430 the identified system/application as specified by the rules included in the applicable location profiles.

For example, assume an appointment is scheduled between 8 AM and 9 AM northern California time (GMT (Greenwich Mean Time)−07:00 Time Zone, the Pacific Time Zone). It is also assumed that a localization rule in the Taiwan profile prohibits business appointments from triggering audio notifications between 10 PM and 7 AM. The user subsequently traveled to Taiwan and stayed there during the time the appointment was scheduled. Because the mobile computing device 110 is located in Taiwan, the Taiwan profile applies. Because Taiwan's time zone is GMT+08:00 (GMT+8), the appointment is scheduled between 11 PM and 12 AM Taiwan time. Therefore, the application manager 310 applies the above localization rule and prohibits audio notification for the appointment. The application manager 310 can be configured to periodically retrieve calendar entries within a pre-determined time period (e.g., next 24 hours) and disable audio notifications for those business appointments scheduled between 10 PM and 7 AM. Alternatively, the application manager 310 can configure the calendar application to stop issuing audio notifications as specified by the rule.

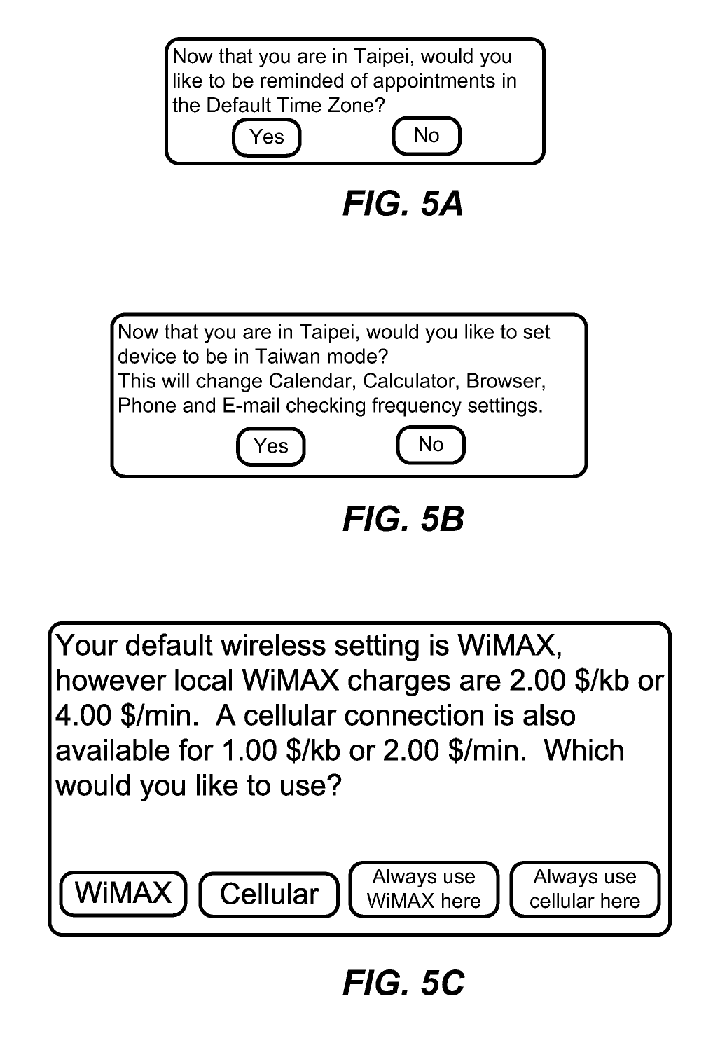

In one embodiment, the localization manager 232 prompts the user for confirmation before localizing 430 any system/application. FIGS. 5A-5C illustrates some example prompting messages. FIG. 5A shows a message that requests the user to decide whether to be reminded of appointments in a default time zone. Appointments in the default time zone are appointments scheduled according to a home (or base) time zone. The user can specify that he wants to be reminded of such appointments by selecting the “Yes” button, or choose to ignore such appointments by selecting the “No” button. Similarly, FIG. 5B shows a message prompting the user to decide whether to apply the Taiwan profile, which involves localizing 430 the calendar, calculator, browser, phone, and email applications. The effect of electing localization is further described below.

FIG. 5C shows a message prompting the user to choose a wireless service provider. As shown, the localization manager 232 identifies the local wireless services providers and determines that the default setting (using WiMAX) may not be economically advantageous compare to another wireless service (cellular network). The pricing information may be previously retrieved from the Internet and stored in the location database 338 or retrieved from local wireless signals. As a result, the localization manager 232 prompts the user of the option of switching to cellular network. The user is given the following four options: WiMAX, Cellular, Always use WiMAX here, and Always use cellular here. If the user selects WiMAX or Cellular, then the localization manager 232 utilizes the specified wireless services for network communication for the current trip. If the user selects one of the latter two options, the localization manager 232 will store the user preference (e.g., as a rule in the corresponding location profile) for future localization and will not display this prompting message to the user again.

### SMART CALENDAR

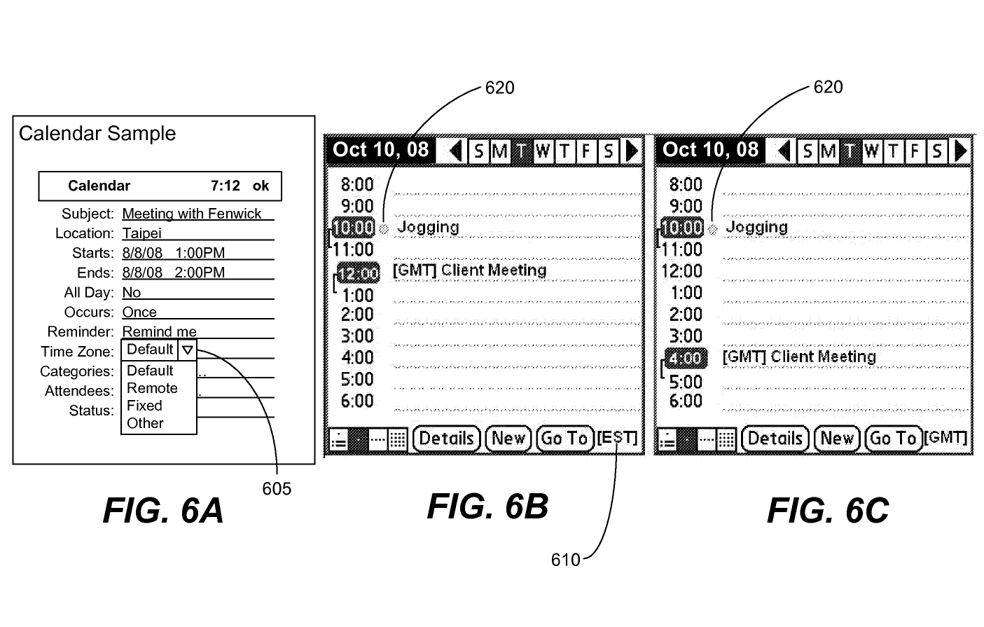

In some embodiments, the localization manager 232 can be configured to be integrated into applications and/or systems. In other embodiments, the localization manager 232 can be configured as a stand alone application configured to interact with existing applications/systems. Described below with reference to FIGS. 6A-6C is a calendar application (hereinafter called smart calendar) that is configured to work with the localization manager 232 to provide users with services that can be customized based on the place the user travels to.

When a user schedules an appointment using the smart calendar, the user is requested to specify a time zone for the appointment. In one embodiment, the smart calendar provides a time zone (or location) selection drop-down menu for the user to select the accompanying time zone (or location).

FIG. 6A shows a user interface for a user to set up an appointment using the smart calendar. As shown, the user interface has a time zone section with a drop-down menu 605 for the user to specify the associated time zone. The drop-down menu includes four options: Default, Remote, Fixed, and Other.

The Default option represents the home time zone (or base or home location, home city) for the user. The Remote option represents a location the user frequently travels to, which in this example configuration is in a different time zone with respect to applicability of the principles disclosed herein relative to the smart calendar. Continues with the example of the user who lives in northern California and frequently travels to Taiwan. For this specific user, the Default would represent the GMT−07:00 Time Zone (also known as GMT−7, the Pacific Time Zone), and the Remote would be GMT+8 for Taiwan. The user can set up the time zone (or location) associated with the Default and the Remote options through the smart calendar or the localization manager 232. In one embodiment, the user can set several Default and/or Remote options (e.g., the user makes frequent trips to Taiwan (GMT+8) and Italy (GMT+1)).

The Fixed option indicates that the underlying appointment should be scheduled at a fixed local time of the mobile computing device 110, no matter what time zone the mobile computing device 110 is physically located. For example, the user can schedule a fixed daily appointment to workout for 30 minutes everyday at 6:00 PM while he is at home time zone (e.g. GMT−7). Later when the user travels to a different time zone (e.g., GMT+8), the workout appointment would still be scheduled at 6:00 PM local time. The Other option indicates that the appointment is associated with a time zone (or location) other than the ones associated with the Default and the Remote. In one embodiment, if the user selects the Other option, the smart calendar will display a complete list of the time zones (or locations) for the user to choose from, or a dialog box for the user to specify the intended time zone (or location). For example, if a user living in California (GMT−7, Pacific Time Zone) wants to schedule a rental car pick-up at 12:00 PM local time in Milan, Italy for an upcoming business trip, he can select the Other option and specify that Milan is the associated location. As a result, the smart calendar would associate the corresponding time zone (GMT+1) with the rental car pick-up appointment. Before the business trip, the rental car pick-up will be shown as scheduled at 4:00 AM local time. Once the user arrives at Milan, the rental car pick-up appointment will be adjusted to be at 12:00 PM local time.

Because the appointments made in the smart calendar are either expressly associated with a time zone (e.g., the Default, Remote, Other options) or independent of any time zone (e.g., the Fixed option), the smart calendar can conveniently adjust these appointments as the user travels to different time zones.

FIGS. 6B and 6C illustrate an example of the smart calendar. While in California (GMT−7), the user sets up a fixed daily appointment for jogging between 10 AM and 11 AM, and scheduled a client meeting in London on, for example, Oct. 10, 2008. Before the user travels to London, the user stops on the east coast (GMT−5 or Eastern Time Zone). While on east coast, the smart calendar displays the schedule for Oct. 10, 2008 as shown in FIG. 6B. The smart calendar indicates that the local time zone is the eastern time zone (EST, GMT−5) 610, that the jogging is scheduled between 10 AM and 11 AM local time on Oct. 10, 2008, and that the client meeting is scheduled between 12 PM and 1 PM local time on the same date. The jogging appointment is a fixed appointment, as indicated by the gray dot 620. The client meeting is associated with the GMT time zone, as indicated by “[GMT]” displayed as a prefix of the appointment title. When the user subsequently travels to London, the smart calendar detects the local time change (e.g., through the localization manager 232), and adjusts the schedules accordingly. As shown in FIG. 6C, the jogging remains between 10 AM and 11 AM London time (because it is a fixed appointment), and the client meeting appointment is adjusted to be between 4 PM and 5 PM, due to the time zone change (from GMT−4 to GMT).

The smart calendar can be integrated with the localization manager 232 or be configured to work with the localization manager 232 to provide localized calendar services. For example, if the smart calendar detects that the user traveled to a different time zone, and the time difference is more than 6 hours compare to the previous local time, the smart calendar can prompt the user to decide whether to trigger an audible and/or visual reminder for appointments between midnight and 6 AM local time. The user can set up localization rules to generate such prompting messages through the smart calendar or the localization manager 232. Alternatively, or in conjunction, the smart calendar can work with the localization manager 232 for applicable location profiles (or rules) to adjust the appointments.

### ADDITIONAL EXAMPLES

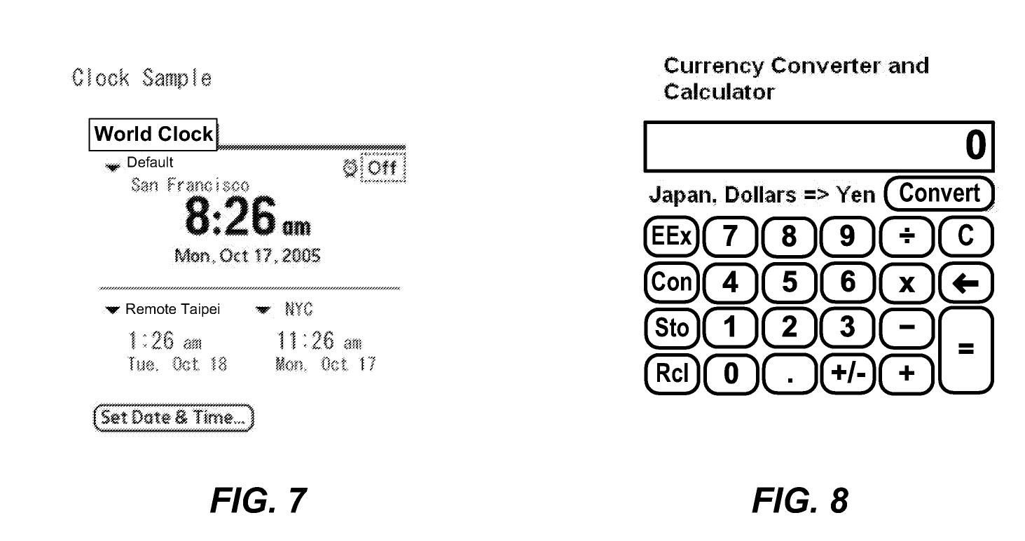

FIGS. 7 and 8 illustrate additional examples of applications localized by the localization manager 232 according to one embodiment of the present disclosure. FIG. 7 illustrates a world clock that is localized based on a device location of the mobile computing device 110. As shown, the world clock displays three times: a Default time for San Francisco, a Remote time for Taipei, Taiwan, and a time for New York City. Note that each physical location name (e.g., city name) is associated with the particular time zone of that location. As described above, the localization manager 232 keeps track of a default location (as specified in the default profile) and a remote location (as specified in the remote profile), and the current device location. If the localization manager 232 determines that the device is currently in New York City (or NYC), then it customizes the world clock to display the three times most relevant to the user, as shown in FIG. 7. If the user subsequently travels to another location (e.g., London, Washington D.C.), then the localization manager 232 will localize the world clock accordingly, even if the local time zone remains the same (e.g., displaying Washington DC rather than NYC). As described above, the user can change the default and remote settings to other locations/time zones.

FIG. 8 is a currency converter and calculator localized by the localization manager 232 according to one embodiment. As shown, the localization manager 232 detects that the device is located in Japan (e.g., through the component manager 308), and that the local currency is Japanese Yen (e.g., through the profile manager 312 and the location database 338). The localization manager 232 customizes the currency converter to set the default currency conversion option to be between Japanese yen and U.S. dollar. If the localization manager 232 subsequently detects that the user travels to England, then the currency converter will be localized to convert currencies between British pound and U.S. dollar. Similarly, conversion applications can also be localized to provide a conversion chart for measurement units that are frequently used in the device location (e.g., for temperature, between degrees Fahrenheit (° F.) and degrees Celsius (° C.), and for length, between meters and feet).

### ALTERNATIVE EMBODIMENTS

Because the localization manager 232 in the mobile computing device 110 can be configured to obtain device location information (e.g., through the component manager 308) and scheduling information (e.g., through application such as the smart calendar), the mobile computing device 110 can provide services that are likely desired by the user. For example, if the calendar indicates that the user is scheduled to travel to Taiwan for the upcoming week, (e.g., through entry of flight information in the calendar) the localization manager 232 can proactively retrieve additional information related to the flight (e.g., flight status, check-in information), the airports (e.g., layout maps), and the destination (e.g., weather, wireless service provider information and pricing information) prior to departure. The mobile computing device 110 can also be configured to provide driving information to the airport based on the device location as the scheduled departing time approaches, turn off the radio subsystem 250 during the scheduled flight time for security reasons, and block reminders that would otherwise go off during regular sleeping time while the user is in Taiwan.

The disclosed embodiments automatically localize systems and/or applications on mobile computing devices as the devices travel to different geographical locations. The disclosure also describes a smart calendar that allows the user to easily set up appointments on a per time zone basis and adjust the appointments based on the device location. This increases ease of use and efficiency of the mobile computing device 110 because the user does not need to concern about the time changes.

Some portions of above description describe the embodiments in terms of algorithmic processes or operations. For example, with respect to descriptions of FIGS. 2, 3, 4 and the examples herein. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for a processor (e.g., the central processor 220) that can be stored in a computer readable storage medium (e.g., the flash memory 214 and/or the RAM 216) and are executable. Furthermore, it has also proven convenient at times, to refer to these arrangements of functional operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a system and a process for localizing applications and systems on a device based on the device location. Thus, while particular embodiments and applications have been illustrated and described, it is to be understood that the present invention is not limited to the precise construction and components disclosed herein and that various modifications, changes and variations which will be apparent to those skilled in the art may be made in the arrangement, operation and details of the method and apparatus disclosed herein without departing from the spirit and scope as defined in the appended claims.

What is claimed is:

1. A method for configuring a mobile computing device to correlate multiple local times, the method comprising:
providing a multiple-choice option for associating a schedule with a time zone, the option including a default time zone, a remote time zone, and a fixed local time;
receiving a user selection of the option for the schedule;
detecting a location of the mobile computing device; and
adjusting the schedule based on the location of the mobile computing device and the user selection of the option for the schedule.

2. The method of claim 1, further comprising:
generating a notification based on the adjusted schedule and user preference information.

3. The method of claim 1, wherein the default time zone is associated with a home time zone of a user, the remote time zone is associated with a time zone the user travels to, the fixed local time is associated with no time zone.

4. The method of claim 3, wherein adjusting the schedule comprises:
adjusting the schedule responsive to a time zone of the location of the mobile computing device being different from a time zone associated with the schedule and the schedule not associated with the fixed local time.

5. The method of claim 1, further comprising:
determining whether to generate the notification for the schedule based on the location of the mobile computing device and a localization rule.

6. A mobile computing device, comprising:
a user interface module configured for providing a multiple-choice option for associating a schedule with a time zone, the option including a default time zone, a remote time zone, and a fixed local time, the user interface module further configured for receiving a user selection of the option for the schedule;
a component manager configured for detecting a location of the mobile computing device; and
a calendar application configured for adjusting the schedule based on the location of the mobile computing device and the user selection of the option for the schedule.

7. The mobile computing device of claim 6, wherein the calendar application is further configured for generating a notification based on the adjusted schedule and user preference information.

8. The mobile computing device of claim 7, further comprising:
a profile manager configured for identifying an applicable localization rule, wherein the calendar application is further configured for determining whether to generate the notification for the schedule based on the location of the mobile computing device and the localization rule.

9. A computer program product for configuring a mobile computing device to correlate multiple local times, the computer program product comprising a computer-readable medium containing computer program code for performing a method comprising:
providing a multiple-choice option for associating a schedule with a time zone, the option including a default time zone, a remote time zone, and a fixed local time;
receiving a user selection of the option for the schedule;
detecting a location of the mobile computing device; and
adjusting the schedule based on the location of the mobile computing device and the user selection of the option for the schedule.

10. The computer program product of claim 9, wherein the method further comprises:
generating a notification based on the adjusted schedule and user preference information.

11. A method for localizing a mobile computing device, comprising:
detecting a location of the mobile computing device;
identifying an applicable location profile based on the location of the mobile computing device, the applicable location profile characterizing a user preference in customizing the mobile computing device and containing a localization rule for localizing an application on the mobile computing device according to the user preference; and
localizing the application based on the localization rule.

12. The method of claim 11, further comprising:
determining a local time based on the device location,
wherein localizing the application based on the localization rule further comprises localizing the application based on the localization rule and the local time.

13. The method of claim 11, further comprising:
detecting a confliction between two applicable localization rules; and
reconciling the confliction by prioritizing one of the two applicable localization rules.

14. The method of claim 11, further comprising:
prompting a user of the mobile computing device for confirmation before localizing the application based on the localization rule.

15. A mobile computing device, comprising:
a component manager configured for detecting a location of the mobile computing device;
a profile manager configured for identifying an applicable location profile based on the location of the mobile computing device, the applicable location profile characterizing a user preference in customizing the mobile computing device and containing a localization rule for localizing an application on the mobile computing device according to the user preference; and
an application manager configured for localizing the application based on the localization rule.

16. The mobile computing device of claim 15, wherein the component manager is further configured for determining a local time based on the device location, and wherein the application manager is further configured for localizing the application based on the localization rule and the local time.

17. The mobile computing device of claim 15, wherein the profile manager is further configured for detecting a confliction between two applicable localization rules, and reconciling the confliction by prioritizing one of the two applicable localization rules.

18. A computer program product for localizing a mobile computing device, the computer program product comprising a computer-readable medium containing computer program code for performing a method comprising:
detecting a location of the mobile computing device;
identifying an applicable location profile based on the location of the mobile computing device, the applicable location profile characterizing a user preference in customizing the mobile computing device and containing a localization rule for localizing an application on the mobile computing device according to the user preference; and
localizing the application based on the localization rule.

19. The computer program product of claim 18, wherein the method further comprises:
determining a local time based on the device location,
wherein localizing the application based on the localization rule further comprises localizing the application based on the localization rule and the local time.

20. The computer program product of claim 18, wherein the method further comprises:
detecting a confliction between two applicable localization rules; and
reconciling the confliction by prioritizing one of the two applicable localization rules.
